(19) United States
(12) Patent Application Publication
(10) Pub. No.: US 2026/0215995 A1
(43) Pub. Date: Jul. 30, 2026

(54) SYSTEM AND METHOD FOR NERVE PAIN TREATMENT

(71) Applicant: Relievvr, LLC, Old Westbury, NY (US)

(72) Inventors: Jonathan BANK, Old Westbury, NY (US); Orr SROUR, Ramat-Hasharon (IL)

(73) Assignee: Relievvr, LLC, Old Westbury, NY (US)

(21) Appl. No.: 19/144,864

(22) PCT Filed: Jun. 5, 2023
(86) PCT No.: PCT/US2023/024429

§ 371 Date: Jun. 30, 2025

Related U.S. Application Data
(60) Provisional application No. 63/441,276, filed on Jan. 26, 2023.

(51) Int. Cl. A61H 23/02

(52) U.S. Cl. CPC A61H 23/02; A61H 2201/165; A61H 2201/5005; A61H 2201/5043; A61H 2201/5097

(57) ABSTRACT

A system for pain treatment includes a vibrating device having a working surface adapted to be positioned on a subject's skin in an affected area, and in embodiments adhered to and conforming to the affected area. The vibrating device generates displacement of the working surface in a plurality of vibratory modes, for example varying a power level, duration and waveform of vibration applied to the affected area to stimulate nerves in the affected area to reduce transmission of pain signals to the subject's brain. One or more vibratory modes and other parameters of a treatment cycle may be saved in profiles and a user may save and select different profiles from onboard or remote storage. A processor, in coordination with an app, is adapted to instruct the device to apply a pattern to the affected area according to a selected profile, and to save and retrieve profiles and related information from storage.

### CROSS REFERENCE TO RELATED APPLICATION

This application claims the benefit of U.S. Provisional Application No. 63/441,276, filed Jan. 26, 2023, which is incorporated by reference.

### BACKGROUND OF THE INVENTION

The invention is directed to a nerve pain treatment device having a vibrating element contacting a subject's skin, a system for controlling the vibration, including applications for storing patterns of vibration allowing a user to formulate, select, test, alter, save and share treatment profiles comprising the treatment patterns, as well as to methods for using the device and system to alleviate nerve pain.

Treatment of nerve pain in post-operative subjects is challenging. The pain may result from nerves being severed or damaged and/or repaired in the course of surgery and pain may persist in the affected area for a long period. Typically, non-steroidal anti-inflammatory drugs (NSAIDs) are prescribed, but many subjects find them ineffective. Prescription narcotics may be prescribed, but these may become habit-forming, or subjects may find them ineffective, and/or subjects may develop resistance to the painkilling effect. And these drugs may have other side effects, or their use may be problematic for other reasons. When opioids do not work, a doctor may prescribe a nerve block. However, there continues to be an unmet need for treatment of nerve pain such as experienced by post operative subjects and others.

Various wearable devices are known that deliver electrical stimulation, heat and/or massaging vibration to a particular body part to ease pain. These devices are usually adapted to stimulate or provide relaxation to muscles and are not adapted specifically for treatment of nerve pain.

Stimulation of nerves to reduce a subjective sensation of pain has been proposed as a treatment for pain. The “gate theory” of nerves proposes that providing stimulation to the sensory fibers component of a nerve may reduce the transmission of pain signals by the component of the nerve that transmits pain signals through the spinal cord and to the brain, in effect “blocking the gate,” so that the subject's brain does not receive the pain signals. In effect, the “pain gate” mechanism saturates the sensory nerves and overwhelms the brain's ability to process pain signals. Generally, these techniques utilize electrical stimulation, as in Transcutaneous Electrical Nerve Stimulation (TENS).

There are challenges in developing a system capable of reliably delivering repeated vibratory stimuli to an affected area having damaged nerves causing pain. Moreover, the experience of pain is subjective, and differs according to the body part affected, the specific nerve trauma experienced, and prior experiences and psychology of the subject as relates to pain. Existing treatment systems based on nerve stimulation have failed to allow sufficient variability in the treatment to allow for physiological differences and/or differences in the subjective perception of pain.

### SUMMARY OF THE INVENTION

The inventors herein have developed systems to deliver variable patterns of vibratory stimulation to an affected area of a subject's body where nerves are located. One object of the invention is to allow subjects themselves to formulate, select, test, alter, save and share treatment profiles that provide the most effective relief.

In one aspect, a system for pain treatment, comprises: a housing enclosing a power source, a motor, and an onboard processor; wherein an outer surface of the housing constitutes a working surface adapted to conform to a subject's skin in an affected area; wherein the motor is adapted to generate displacement of the surface in a plurality of vibratory modes; wherein displacement of the surface in the plurality of vibratory modes is adapted to stimulate nerves in the affected area to reduce transmission of pain signals to the subject's brain; and wherein said onboard processor is adapted to generate and change a pattern of said plurality of vibratory modes in accordance with instructions from the onboard processor.

In embodiments, the working surface comprises an adhesive layer adapted to adhere the working surface to the subject's skin in the affected area for a time sufficient to conduct a treatment regimen. The adhesive layer may be protected by a removable plastic film prior to positioning the working surface against the affected area.

The housing may include indicator(s), such as one or more LEDs providing information about the state of the device. The housing may have one or more buttons controlling the processor and the motor. Alternatively, or in addition, a remote processor, such as on a user's mobile phone, may be adapted to communicate with and control the onboard processor. In embodiments, the remote processor is adapted to store and index a plurality of vibratory patterns in memory (which may be cloud storage), to receive user input of user experience of said vibratory modes and to communicate stored and indexed treatment profiles remotely.

A method of using the device to treat nerve pain may comprise positioning the device on the skin of a subject at an affected area and using at least one vibratory mode for a predetermined period of time to achieve a reduction in pain felt by the subject.

In embodiments, a user constructs a waveform or vibratory pattern using onboard controls or an app and the waveform may become part of a profile. A user may provide instructions to a remote processor (using a mobile phone, for example) to set the treatment profile or waveform including, for example, amplitude, attack and decay characteristics, and on-off duty cycle. The user may save the constructed profile or waveform in the mobile phone memory or to a remote database. The app may instruct the processor to activate the vibrating element to treat the affected area according to the constructed waveform or profile for a period of time to effect a treatment cycle. In embodiments, following the treatment cycle, the user may rate an experience of at least one attribute of pain, and this feedback information may be associated with the profile and/or the user in a database.

In embodiments, anonymized feedback information about treatment profiles from a plurality of users may be collected and used to provide suggestions to a user or a community of users. For example, a program may analyze a plurality of anonymized treatment profiles and suggest a treatment profile generated by an analysis. Alternatively, or in addition, a program may display a history of past treatment profiles and allow a user to select from past treatment profiles.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of a computing device, according to some embodiments of the invention;

FIG. 2 schematically depicts a user interface and control system according to embodiments of the invention;

FIG. 3A, FIG. 3B and FIG. 3C depict various schematic views of a body-contacting housing enclosing a vibrating element according to embodiments of the invention;

FIG. 4A depicts preset vibration patterns which may be used to make one or more profiles according to embodiments of the invention; and

FIG. 4B depicts waveform parameters that may be manipulated to create one or more vibratory waveforms or profiles according to embodiments of the invention.

It will be appreciated that for simplicity and clarity of illustration, elements shown in the figures have not necessarily been drawn to scale and some elements not necessary for an understanding of the invention have been omitted. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing”, “computing”, “calculating”, “determining”, “establishing”, “analyzing”, “checking”, “saving”, “formulating”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set,” when used herein, may include one or more items.

The body-contacting element of the system comprises a housing having one wall positioned to contact a body part. The body part may be a subject's breast or other body part. The working surface wall may be made flexible to transmit vibration with sufficient sensitivity and/or may be provided with a contour to adapt the working surface to conform to a body part contour. The device may contact the subject's skin in an affected area and in embodiments an entire wall on one side of the housing constitutes the working surface. The device need not be adhesively attached to the subject's body provided that sufficient confirming contact is provided to impart a vibration pattern to the desired area. In embodiments, the device may be securely positioned against the subject's skin using a suitable bioadhesive, thereby conforming the working surface to a contour of the subject's body. A “wearable” configuration may also be used according to embodiments of the invention, for example by strapping a housing onto the affected area with bandages or the like or positioning the housing in a pocket insert in a bra or other article of clothing that may hold the working surface proximate the body part of interest. Other embodiments utilize a silicone-based bioadhesive for firm contact between a continuous, flexible, body-contacting wall of the housing and the body part. In embodiments, a removable backing layer is provided over an adhesive which is removed before the adhesive on the working surface is applied against the treatment area on the subject's skin.

Also within the housing is a motor, which may be any movable mechanical structure that provides a programmed vibrating motion to the working surface, for example an eccentric motor or a piezoresistive element or other motor. A power source, such as a battery, may also be located within the housing to enable the motor to run. The battery may be rechargeable and the housing adapted for wireless or wired recharging.

One or more processors within the housing may include: a motor controller controlling the vibration patterns; a communication module allowing the motor to interact with the control application; a user interface; and a management module for managing the device communication, power states and vibration control.

The housing may include user-accessible physical buttons for immediate action and control, a recess or magnetic port for charging and a cover over the working surface which may form an enclosure around the internal components, including the battery, onboard processor, and motor. LEDs or other visual indicator(s) may be provided on the housing to indicate state of charge of the battery, power on/off state, connectivity, and the like.

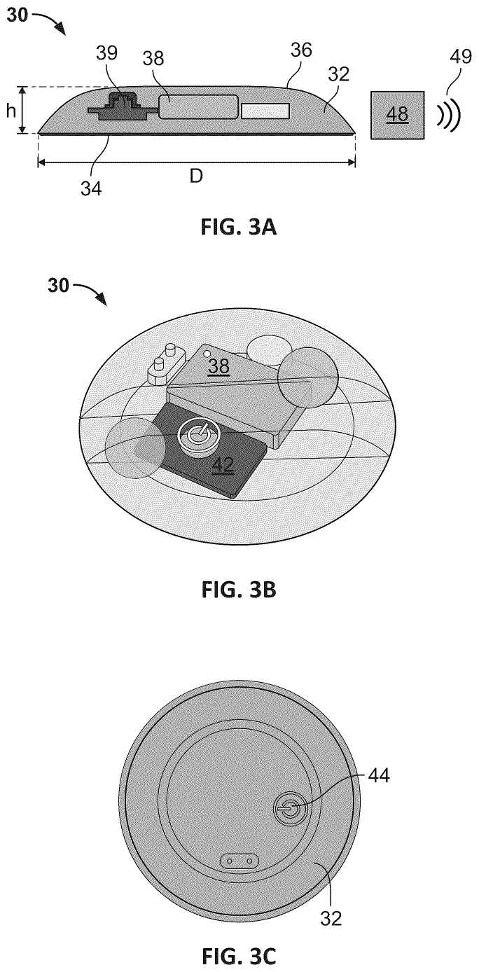

FIG. 3A depicts a cross-sectional view according to an embodiment in which a low-profile body-contacting element 30 comprises housing 32 having a working surface 34 and a domed cover 36. “Low profile” means that the diameter “D” of the working surface or wall (or longest dimension if the working surface is not a circle) may be significantly larger than the height “h” of the device. In embodiments, the ratio of working surface diameter to height may be 10:1, 20:1, or greater. Housing 32 is preferably soft so that it may be comfortably positioned proximate the body, as the exterior of domed cover 36 may be expected to contact body parts, albeit not to the extent that working surface 34 does. Housing 32 may be made watertight to protect the internal working parts. As seen in FIG. 3B and FIG. 3C, the internal working parts in this embodiment include an enclosed battery 38 (which may be rechargeable, for example by a magnetic charger or via a charging port), motor 39, and printed circuit (PCB) 42 including a processor, which is accessed by user-operable controls, both directly on the device (such as on off switch 44) and remotely by remote processor 48, which may be a user's cell phone or other remote computing device.

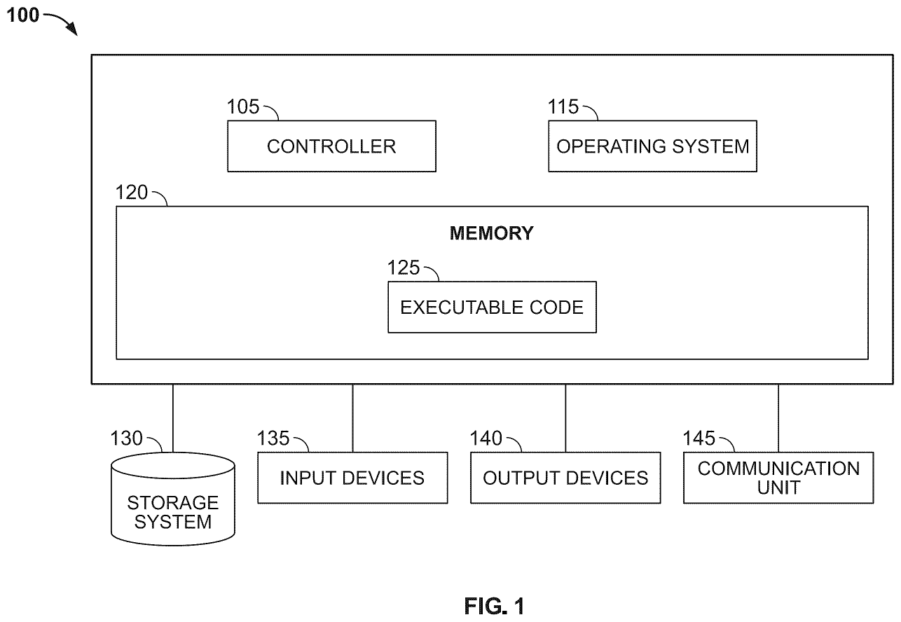

The onboard processor 42 may be supplemented by remote processor 48 controlled by an app, run on a smartphone for example, which maybe operatively connected to onboard processor on PCB 42 via a wireless connection 49. Reference is made to FIG. 1, which is a block diagram of an exemplary computing device, according to some embodiments of the invention, and may also describe onboard processor on PCB 42 and remote processor 48 and the combination of them. Computing device 100 may include a controller or processor 105 (e.g., a central processing unit processor (CPU), a chip or any suitable computing or computational device), an operating system 115, memory 120, executable code 125, storage 130, input devices 135 (e.g. a keyboard or touchscreen), and output devices 140 (e.g., a display), a communication unit 145 (e.g., a cellular transmitter or modem, a Wi-Fi communication unit, or the like) for communicating with remote devices via a communication network, such as, for example, the Internet.

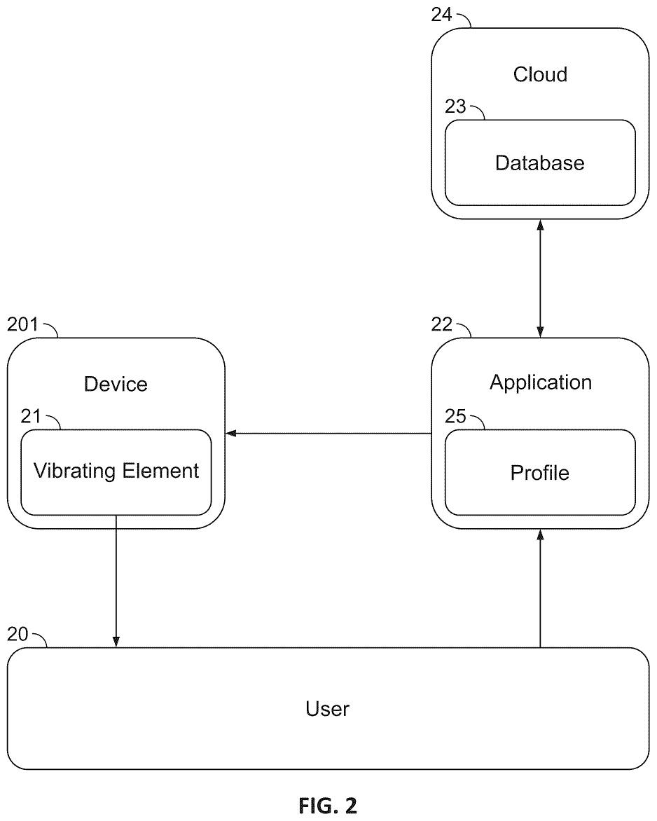

Controller 105 may be configured to execute program code to perform operations described herein. The system described herein may include one or more computing device(s) 100, for example, to act as the various devices or the components shown in FIG. 2. For example, device 201 may be, or may include computing device 100 or components thereof and application 22 may be or may include executable code running on a user computing device 100 such as a smartphone.

Operating system 115 may be or may include any code segment (e.g., one similar to executable code 125 described herein) designed and/or configured to perform tasks involving coordinating, scheduling, arbitrating, supervising, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of similar and/or different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be a software application that performs methods as further described herein. Although, for the sake of clarity, a single item of executable code 125 is shown in FIG. 1, a system according to embodiments of the invention may include a plurality of executable code segments similar to executable code 125 that may be stored into memory 120 and cause controller 105 to carry out methods described herein.

Storage 130 may be or may include, for example, a hard disk drive, a universal serial bus (USB) device or other suitable removable and/or fixed storage unit. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a keyboard, a touch screen or pad, one or more sensors or any other or additional suitable input device. Any suitable number of input devices 135 may be operatively connected to computing device 100. Output devices 140 may include one or more displays or monitors and/or any other suitable output devices. Any suitable number of output devices 140 may be operatively connected to computing device 100. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105. Such a non-transitory computer readable medium may be for example a memory, a disk drive, or a USB flash memory, encoding, including or storing instructions, e.g., computer-executable instructions, which when executed by a processor or controller, carry out methods disclosed herein.

The storage medium may include, but is not limited to, any type of disk including, semiconductor devices such as read-only memories (ROMs) and/or random-access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium. Remote storage and processing may be referred to as “cloud” storage and processing.

A system according to embodiments of the invention may include components such as, but not limited to, a plurality of central processing units (CPUs), a plurality of graphics processing units (GPUS), or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components.

In some embodiments, a system may include or may be, for example, a personal computer, a desktop computer, a laptop computer, a workstation, a server computer, a network device, or any other suitable computing device. For example, a system as described herein may include one or more facility computing device 100 and one or more remote server computers in active communication with one or more facility computing device 100 such as computing device 100, and in active communication with one or more portable or mobile devices such as smartphones, tablets and the like.

FIG. 2 depicts a relationship between a “user” 20 (or a plurality of users), device 201, including vibrating element 21, application (“app”) 22, and one or more memory and/or database 23, which may be remote (such as cloud storage 24), or local (e.g., saved on a user's computer). User 20 may select various vibration patterns and power levels (referred to as elements of a profile 25) using manual control on the device, or through app 22 (e.g. a mobile phone application). The app 22 may communicate instructions from user 20 to device 21 via wired connection or wirelessly to implement profile 25. One or more memory and/or database 23 may contain a plurality of saved profiles of the user and other users, and information related to the saved profiles. A saved profile may be transmitted from memory and/or database 23 to the app on a user computer and then applied to device 21 and user 20. The terms “user” and “subject” are used almost interchangeably herein. However, it is understood that the subject being treated is often also the user of the app—controlling the operation of the vibrating element and creating profiles. Of course, a physician or other entity may also be a user of the app, setting up profiles and obtaining data for the subject.

Thus, user(s) 20 may create and save a profile on a smart phone or other device using an app 22. App 22 communicates with the vibrating element in the device to deliver vibration to an affected area of the subject's body according to a certain pattern and app 22 may communicate with remote storage where one or more profiles may be stored and sorted. For example, a user may record what dates a profile is used and for how long. The profiles that are most successful at treating pain, based on user feedback, may be ranked and shared by a user. Anonymized data may be analyzed to identify and rank the most effective profiles among a plurality of users.

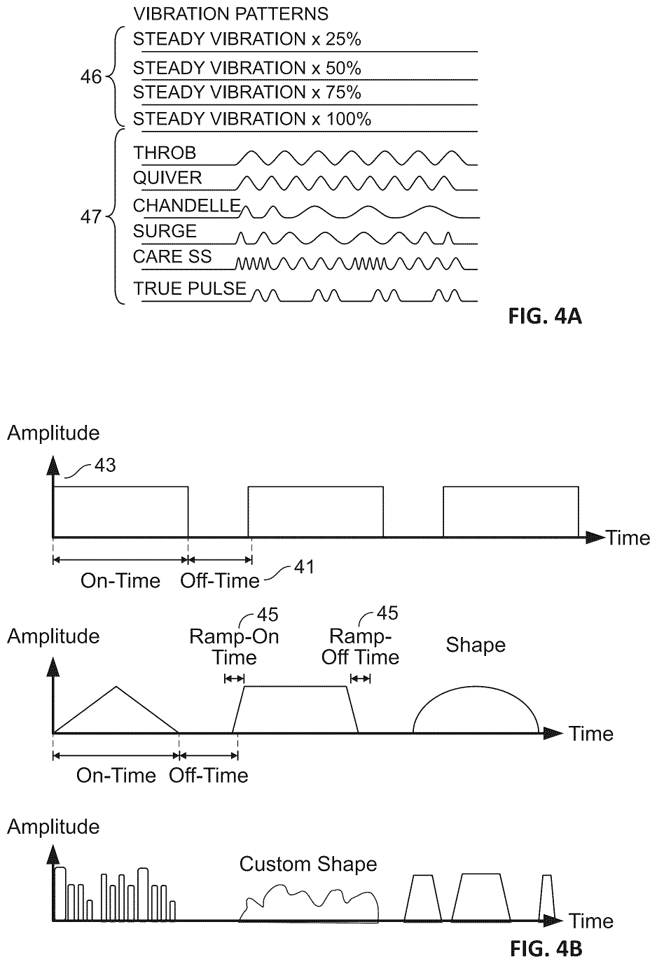

Referring to FIG. 4A, the control application allows the user to modify vibration pattern(s) that may be implemented by the processor and applied by the working surface to an affected area. The user may construct a profile from preset waveforms 47 as shown in FIG. 4A, which may be given memorable names like “throb,” “true pulse,” and “caress.” Alternatively, a user may select one or more steady vibration modes 46 at a selected power level. A single waveform may constitute a “profile,” or alternatively, a waveform is constructed from a plurality of waveform elements. Thus, referring to FIG. 4B, a user may select amplitude of a vibration 43 and an on/off time (“duty cycle”) 41. Attack and decay characteristics 45 of each waveform may be customized, according to the complexity of the user interface and user preferences.

In embodiments, the application can receive feedback from the subject relating to the subject's subjective experience of pain and thus monitor the pain level of the user before, during and after using of the device. These types of data may be collected from a plurality of users, and profiles and activity linked, for manual analysis by the user(s) or automated analysis employing algorithms, and artificial intelligence (AI). A cloud service may gather information collected during usage of the device from a plurality of subjects, including but not limited to the type of the pain, its intensity and physical location, physical location of the device on patient body, profiles tested to reduce the pain, profiles usage duration, effectiveness in pain relief (measurements before, during and after treatment), time between usages, pain intensity over time, etc. These data and results of these analyses may be indexed for later use by one or more users.

Thus, the processor(s) controlling the device may also record and relate pain intensity to the configurable profiles, measuring and noting their effectiveness. Profiles and activity can be shared between users to help those with similar problems. Profiles suggested by others with similar scenarios/patterns/pains can be retrieved and tested by the user.

Treatment using the app and device according to the invention may be combined with additional biofeedback methods, such as sound and visual images that accompany the physical vibration to help ease and relax the user.

All this data may be collected over time per user or anonymously, and used for prediction, estimation and suggestions offered to users, tailored to their specific needs and pain scenarios. It may allow for future study of postoperative pain profiles and effectiveness of treatments. With user permission it allows sharing pain data and status back to a treating physician for continuous monitoring of the patient's condition.

Unless explicitly stated, the method embodiments described herein are not constrained to a particular order or sequence. Additionally, some of the described method embodiments or elements thereof may occur or be performed simultaneously, at the same point in time, or concurrently.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for pain treatment, comprising:
a housing enclosing a power source, a motor and an onboard processor;
wherein an outer surface of the housing constitutes a working surface adapted to conform to a subject's skin in an affected area;
wherein the motor is adapted to generate displacement of the surface in a plurality of vibratory modes;
wherein said displacement of the surface in a plurality of vibratory modes is adapted to stimulate nerves in the affected area to reduce transmission of pain signals to the subject's brain;
wherein said onboard processor is adapted to generate and change a pattern of said plurality of vibratory modes in accordance with instructions from the processor.

2. The system according to claim 1, wherein the working surface comprises an adhesive layer adapted to adhere the working surface to the subject's skin in the affected area for a time sufficient to conduct a treatment regimen.

3. The system according to claim 1, wherein the adhesive layer consists of a silicone-based bioadhesive.

4. The system according to claim 3, further comprising a removable non-adhesive backing layer on said adhesive layer adapted to be removed prior to positioning the working surface on the subject's skin.

5. The system according to claim 1, further comprising a wearable casing adapted for insertion of the housing and adapted to be attached to the subject's body to position the working surface adjacent the affected area.

6. The system according to claim 1, further comprising a remote processor adapted to communicate with and control the onboard processor.

7. The system according to claim 6, wherein the remote processor is on a mobile phone and the remote processor communicates with and controls the onboard processor using an app.

8. The system according to claim 6, wherein the remote processor is adapted to store and index a plurality of patterns of vibratory modes; and to receive user input of user experience of said vibratory modes.

9. The system according to claim 8, wherein the remote processor is adapted to communicate stored and indexed patterns of vibratory modes and user input information to a remote database.

10. The system according to claim 1, wherein said housing comprises one or more buttons controlling the processor and the motor.

11. The system according to claim 1, wherein the power source is a rechargeable battery and said housing comprises a charger port or wireless charging location.

12. The system according to claim 1, wherein the motor is flat eccentric motor.

13. A method for treating nerve pain, comprising: positioning a device on the skin of a subject at an affected area, said device comprising a housing enclosing a power source, a motor and an onboard processor; wherein an outer surface of the housing constitutes a working surface adapted to conform to a subject's skin in an affected area; wherein the motor is adapted to generate displacement of the surface in a plurality of vibratory modes; wherein said displacement of the surface in a plurality of vibratory modes is adapted to stimulate nerves in the affected area to reduce pain; and wherein said onboard processor is adapted to generate and change a pattern of said plurality of vibratory modes in accordance with instructions from the processor; the method comprising
stimulating nerves by applying at least one vibratory mode to the affected area with the working surface for a predetermined period of time to achieve a reduction in pain experienced by the subject.

14. The method according to claim 13, comprising constructing a profile by selecting, with a processor, one or more preset vibratory modes, at least one corresponding duration, and amplitude.

15. The method according to claim 14, comprising receiving user feedback following treatment for the predetermined period of time and associating the user feedback with the profile in memory.

16. The method according to claim 14, comprising constructing the profile with a remote processor wirelessly connected to the onboard processor.

17. The method according to claim 16, comprising saving one or more profiles to a memory and retrieving one or more profiles from memory

18. The method according to claim 16, comprising saving one or more profiles to remote cloud-based storage

19. The method according to claim 13, comprising: with a remote processor, setting a treatment profile comprising at least one vibratory mode and at least one amplitude, treating the affected area for a period of time with said treatment profile to effect a treatment cycle; rating by a user at least one attribute of pain with the remote proceessor; and logging by the remote processor said treatment profile, corresponding treatment cycle and rating for a plurality of treatment cycles.

20. The method according to claim 19, comprising selecting a suggested treatment profile generated by an analysis by the remote processor of anonymized treatment profiles.

21. The method according to claim 19, comprising selecting a suggested profile from a history of past treatment profiles of the subject displayed to the subject by the remote processor.

22. The method according to claim 19, comprising transmitting anonymized treatment profiles and ratings to cloud-based data storage.
